(19) United States
(12) Patent Application Publication
(10) Pub. No.: US 2025/0210892 A1
(43) Pub. Date: Jun. 26, 2025

(54) CONNECTOR

(71) Applicant: SUMITOMO WIRING SYSTEMS, LTD., Mie (JP)

(72) Inventor: Yusuke YAMOTO, Mie (JP)

(21) Appl. No.: 18/978,658

(22) Filed: Dec. 12, 2024

(30) Foreign Application Priority Data
Dec. 21, 2023 (JP) 2023-215536

(51) Int. Cl. H01R 12/70

(52) U.S. Cl. CPC H01R 12/7064

(57) ABSTRACT

A connector 1 includes: a terminal fitting 11 including a mate connection portion 11A and a board connection portion 11B; a housing 10 through which the mate connection portion 11A is inserted and held; and an alignment plate 12 attached to the housing 10 and having an insertion hole 12D capable of positioning the board connection portion 11B. A part of the board connection portion 11B located within the insertion hole 12D is configured as an elastic portion 11D that is elastically deformable in a width direction perpendicular to an axial direction Ad of the board connection portion 11B.

### CROSS-REFERENCE TO RELATED APPLICATIONS

This application is based on and claims priority from Japanese Patent Application No. 2023-215536, filed on Dec. 21, 2023, with the Japan Patent Office, the disclosure of which is incorporated herein in its entirety by reference.

### TECHNICAL FIELD

The present disclosure relates to a connector.

### BACKGROUND

JP 2008-226571A discloses an alignment plate having a plurality of positioning holes through which contacts (board connection portions) are inserted. Each positioning hole of the alignment plate is provided with a plurality of elastic pieces. The elastic pieces elastically contact the contact inserted into the positioning hole to support and position the contact. JP 2022-086496A and JP 2004-031006A each disclose a technique that simply inserts board connection portions into insertion holes formed in an alignment plate to position the board connection portions. JP 2000-260513A discloses a technique that uses press fit to connect boards to each other.

### SUMMARY

If, after mounting, an alignment plate expands or contracts due to heating or cooling and deforms, the terminal fittings inserted into the positioning holes of the alignment plate move along with the alignment plate, which may cause stress on the board. With the structure described in JP 2008-226571A, even if the alignment plate deforms, the elastic pieces elastically deform to prevent the board connection portion from deforming. However, the technique in JP 2008-226571A needs to secure space around each positioning hole in order to provide the elastic pieces, so that the distance between adjacent contacts cannot be made very close. The technique in JP 2008-226571A is therefore disadvantageous in reducing the size of the connector. A technique that can position the contacts and reduce the size of the connector is thus desired.

The present disclosure therefore has an object of providing a connector that can position board connection portions and can be reduced in size.

A connector according to the present disclosure is a connector including: a terminal fitting including a mate connection portion and a board connection portion; a housing through which the mate connection portion is inserted and held; and an alignment plate attached to the housing and having an insertion hole capable of positioning the board connection portion, wherein a part of the board connection portion of the terminal fitting located within the insertion hole is configured as an elastic portion that is elastically deformable in a width direction perpendicular to an axial direction of the board connection portion.

According to the present disclosure, it is possible to position board connection portions and reduce the size of a connector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to the present disclosure.

FIG. 2 is an enlarged perspective view of a board connection portion of a terminal fitting according to the present disclosure.

FIG. 3 is a perspective view of the connector according to the present disclosure as seen from the back.

FIG. 4 is a partial back view of part of a housing with terminal fittings attached before an alignment plate is attached, as seen from the back.

FIG. 5 is a partial plan view of part of the alignment plate according to the present disclosure as seen from above.

FIG. 6 is a cross-sectional view taken along line A-A in FIG. 5.

FIG. 7 is a partial back view of the connector with the alignment plate attached, as seen from the back.

FIG. 8 is a partial back view of the connector shown in FIG. 7 attached to a board, as seen from the back.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF THE PRESENT DISCLOSURE

First, embodiments of the present disclosure will be listed and described below.

(1) A connector including: a terminal fitting including a mate connection portion and a board connection portion; a housing through which the mate connection portion is inserted and held; and an alignment plate attached to the housing and having an insertion hole capable of positioning the board connection portion, wherein a part of the board connection portion of the terminal fitting located within the insertion hole is configured as an elastic portion that is elastically deformable in a width direction perpendicular to an axial direction of the board connection portion.

If the alignment plate is heated or cooled, its volume expands or contracts. In this case, the insertion hole also expands or contracts, and becomes larger or smaller. Thus, when the alignment plate expands or contracts, a pressing force is applied from the alignment plate to the board connection portion in a direction perpendicular to the axial direction, which may cause stress on the circuit board to which the board connection portion is connected. The connector of (1) can, even if the alignment plate expands or contracts, absorb the pressing force from the alignment plate by the elastic portion of the terminal fitting and prevent stress from being applied to the circuit board to which the board connection portion is connected. Since the alignment plate does not need to have an elastically deforming structure, the distance between the insertion holes can be narrowed easily, which is advantageous in reducing the size of the connector.

(2) The connector according to (1), wherein a part of the board connection portion to be located within a through hole of a circuit board is configured as a press fit portion that is elastically deformable in the width direction.

The connector of (2), as a result of having the press fit portion that is elastically deformable, can further prevent stress from being applied to the circuit board even if the board connection portion is moved by the alignment plate.

(3) The connector according to (2), wherein a maximum width of the press fit portion in the width direction is smaller than a minimum dimension of the insertion hole in the width direction.

The connector of (3) can suppress insertion resistance that occurs when the press fit portion is inserted into the insertion hole.

(4) The connector according to (2) or (3), wherein the elastic portion includes a pair of extension portions extending in the axial direction and connected to each other at both ends in the axial direction, and a hole portion formed between the pair of extension portions, and a dimension of the hole portion in the axial direction is larger than a dimension of an eyehole of the press fit portion in the axial direction.

The connector of (4), as a result of having the elastic portion that is more flexible than the press fit portion, can flexibly absorb the pressing force applied from the alignment plate easily and consequently can further prevent stress from being applied to the circuit board.

(5) The connector according to any of (1) to (4), wherein an opening shape of the insertion hole is circular.

The connector of (5) can easily stabilize the contact of the insertion hole with the elastic portion even if the elastic portion tilts with respect to the axis of the board connection portion.

(6) The connector according to any of (2) to (4), wherein the terminal fitting includes a projection portion located on an opposite side of the elastic portion from the press fit portion and projecting in the width direction, of both ends of the projection portion in the axial direction, an end located on an opposite side from the press fit portion is configured as a jig pressing surface in the width direction, and outer edges of the elastic portion in the width direction are connected, without constriction, to outer edges of the projection portion in the width direction.

The connector of (6) can simplify the process of forming the terminal fitting because the elastic portion and the projection portion can be formed integrally.

### Details of Embodiments of the Present Disclosure

### Embodiment 1

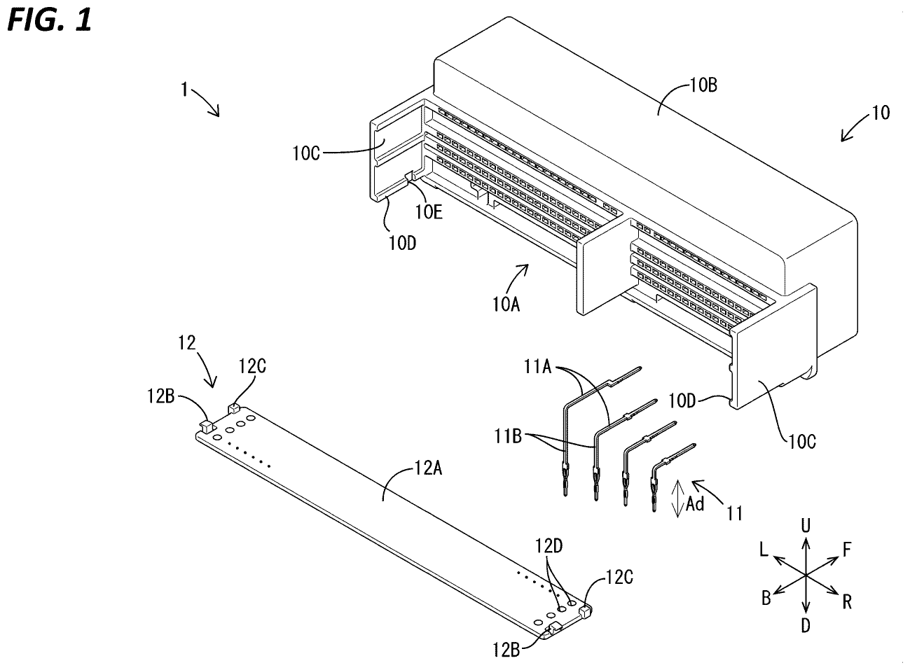

A connector 1 according to Embodiment 1 of the present disclosure will be described with reference to FIGS. 1 to 8. In the drawings, front, back, up, down, right, and left are represented by “F”, “B”, “U”, “D”, “R”, and “L”, respectively. The directional references are defined for convenience, and do not necessarily coincide with the directions when the connector 1 is mounted on a vehicle or the like. For example, the up-down direction is not limited to the direction of gravity.

As shown in FIG. 1, the connector 1 includes a housing 10, a plurality of terminal fittings 11, and an alignment plate 12. The housing 10 is made of synthetic resin, and includes a terminal holding portion 10A, a hood portion 10B, and a pair of symmetrical side wall portions 10C. The terminal holding portion 10A is a rectangular wall with its wall thickness direction corresponding to the front-back direction. The hood portion 10B protrudes forward from the outer periphery of the terminal holding portion 10A in a rectangular tubular shape.

The side wall portions 10C protrude backward from the left and right ends of the back surface of the terminal holding portion 10A, with their wall thickness direction corresponding to the left-right direction (direction perpendicular to the wall thickness direction of the terminal holding portion 10A). A pair of symmetrical locking portions 10D are formed on the respective side wall portions 10C. Each locking portion 10D of the housing 10 extends in the front-back direction, and protrudes inward in the left-right direction from the lower edge of the side wall portion 10C on the inner side in the left-right direction. A guide groove 10E is formed in the center part of each locking portion 10D in the front-back direction. The guide groove 10E is formed so that the locking portion 10D will be recessed outward in the left-right direction. Only the guide groove 10E of the left locking portion 10D is shown in FIG. 1.

Each of the plurality of terminal fittings 11 is an elongated metal material bent into an L-shape. Each terminal fitting 11 includes a mate connection portion 11A extending in the front-back direction and a board connection portion 11B extending downward at a right angle from the back end of the mate connection portion 11A. The upper end (base end) of the board connection portion 11B is connected to the back end of the mate connection portion 11A. Not all but only some of the terminal fittings 11 are shown in FIG. 1.

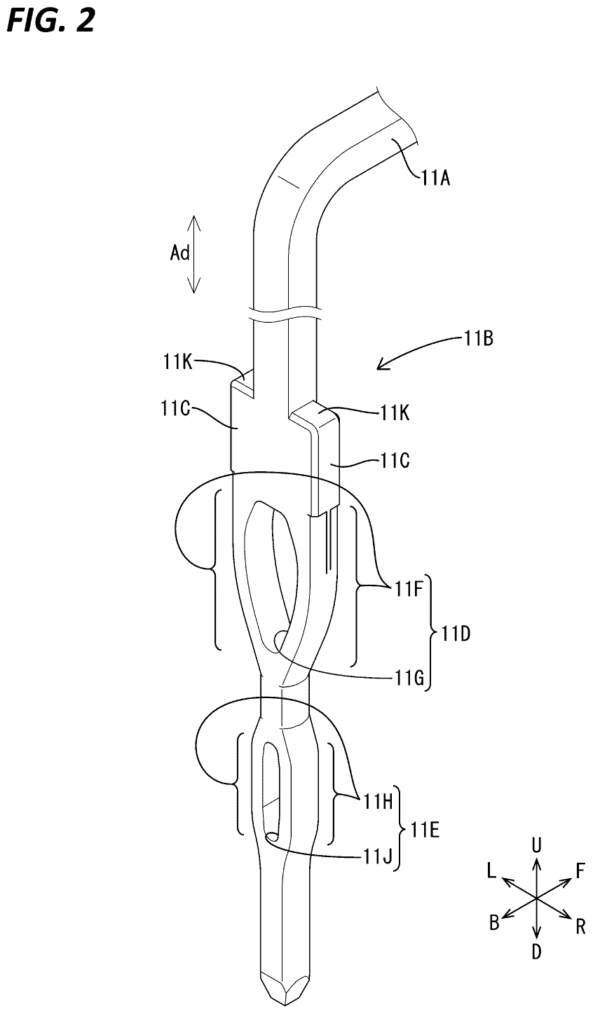

As shown in FIG. 2, the lower end (tip end) of the board connection portion 11B is provided with a pair of projection portions 11C, an elastic portion 11D, and a press fit portion 11E. The pair of projection portions 11C project outward in the left-right direction (width direction). Of both ends of each projection portion 11C in the axial direction Ad, the end located on the opposite side from the press fit portion 11E is formed as a jig pressing surface 11K in the left-right direction (width direction). When inserting the board connection portion 11B into a through hole H of a circuit board S, a jig (not shown) is pressed against the jig pressing surface 11K from above.

The elastic portion 11D is connected to the lower side of the pair of projection portions 11C. The elastic portion 11D includes a pair of extension portions 11F and a hole portion 11G formed between the pair of extension portions 11F. The pair of extension portions 11F have their upper ends connected to each other, and extend downward from the lower ends of the pair of projection portions 11C. The lower ends of the pair of extension portions 11F are connected to each other. The pair of extension portions 11F extend in the axial direction Ad of the board connection portion 11B, and are connected to each other at both ends in the axial direction Ad.

The pair of projection portions 11C and the pair of extension portions 11F are connected to each other with their outer edges in the left-right direction flush with each other without a constriction. In other words, the outer edges of the elastic portion 11D in the left-right direction (width direction) are connected to the outer edges of the pair of projection portions 11C in the left-right direction (width direction) without a constriction. The lower part of the pair of extension portions 11F is curved so as to decrease in the width in the left-right direction. When the pair of extension portions 11F are pressed inward in the left-right direction from the outside in the left-right direction, the pair of extension portions 11F elastically deform inward in the left-right direction so as to decrease in the width in the left-right direction, and enter the hole portion 11G. When the pressing is stopped, the pair of extension portions 11F elastically return to their original state.

The press fit portion 11E is connected to the lower side of the elastic portion 11D. That is, the projection portions 11C are located on the opposite side of the elastic portion 11D from the press fit portion 11E. The press fit portion 11E includes a pair of curved extension portions 11H and an eyehole 11J. The pair of curved extension portions 11H extend in the up-down direction, with their upper ends connected to each other and their lower ends connected to each other. The center parts of the pair of curved extension portions 11H in the up-down direction are curved outward in the left-right direction so as to separate from each other.

The eyehole 11J is formed between the pair of curved extension portions 11H. The dimension of the hole portion 11G in the axial direction Ad is larger than the dimension of the eyehole 11J in the axial direction Ad. The elastic portion 11D and the press fit portion 11E are connected to each other so that the outer edges in the left-right direction will be constricted inward in the left-right direction. The maximum width of the press fit portion 11E in the left-right direction is smaller than the maximum width of the elastic portion 11D in the left-right direction. When the pair of curved extension portions 11H are pressed inward in the left-right direction from the outside in the left-right direction, the pair of curved extension portions 11H elastically deform inward in the left-right direction so as to decrease in the width in the left-right direction, and bend and enter the eyehole 11J. When the pressing is stopped, the pair of curved extension portions 11H elastically return to their original state.

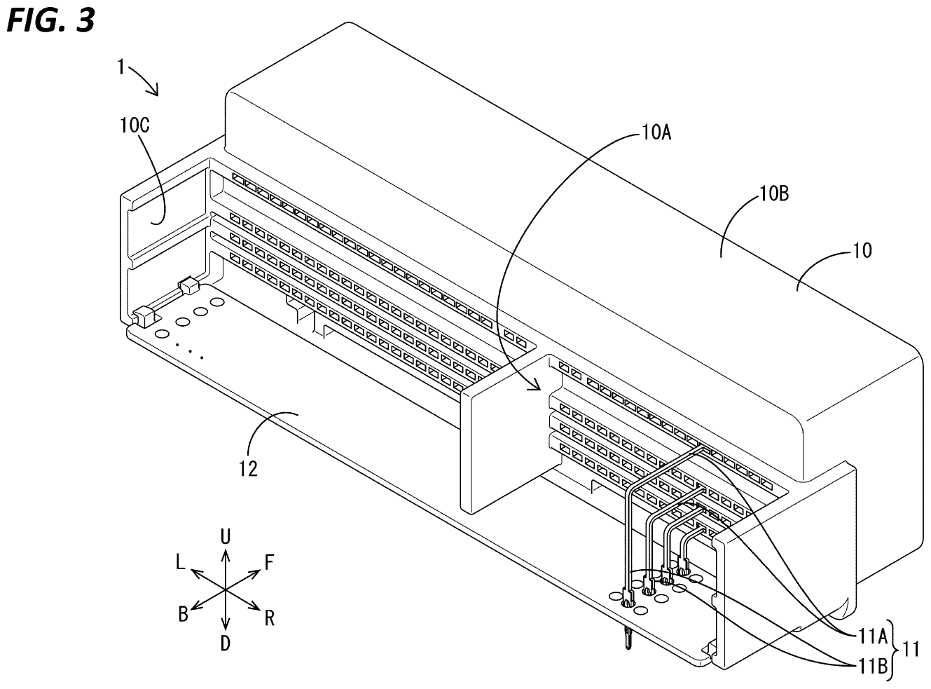

As shown in FIG. 3, each terminal fitting 11 is held by the terminal holding portion 10A with the mate connection portion 11A inserted through the terminal holding portion 10A in the front-back direction. In a state in which the plurality of terminal fittings 11 are attached and fixed to the housing 10, the mate connection portions 11A are arranged in parallel with each other and the board connection portions 11B are arranged in parallel with each other. The front end of each mate connection portion 11A protrudes forward from the front surface of the terminal holding portion 10A into the hood portion 10B (not shown).

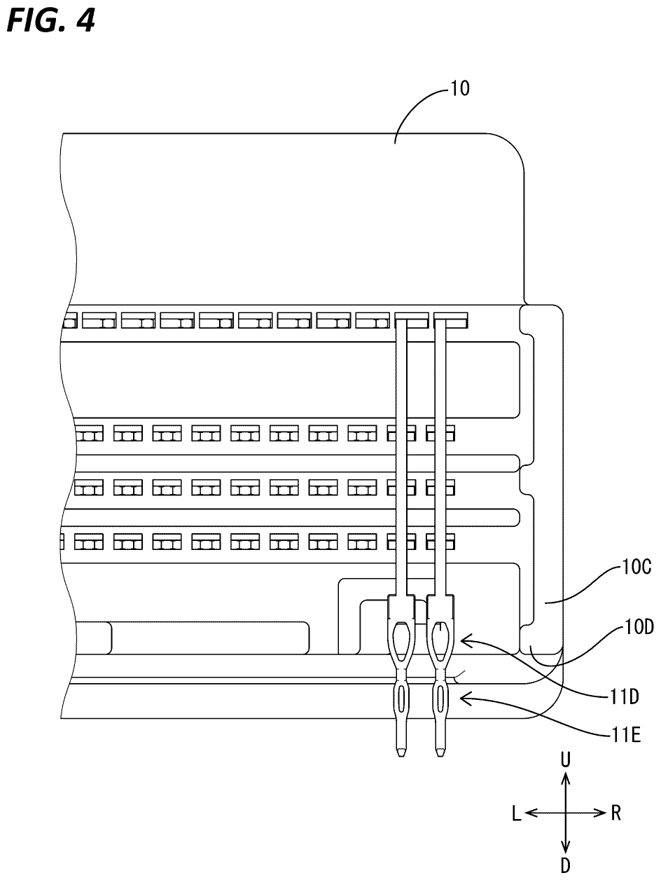

The back end of the mate connection portion 11A and the entire board connection portion 11B are exposed to the back of the terminal holding portion 10A. The lower end of the elastic portion 11D and the press fit portion 11E protrude downward beyond the lower edge of each side wall portion 10C (see FIG. 4).

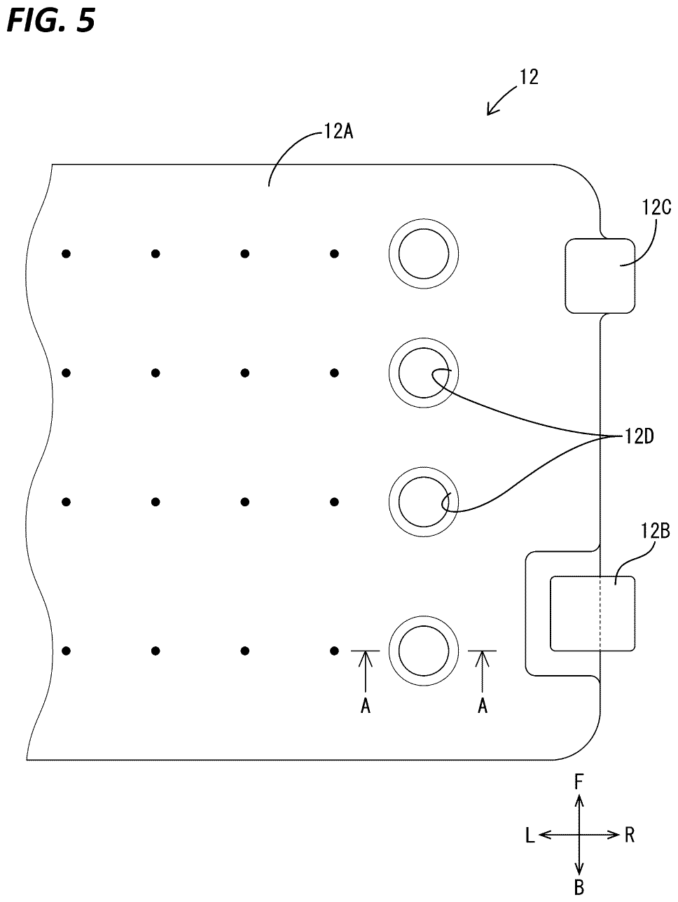

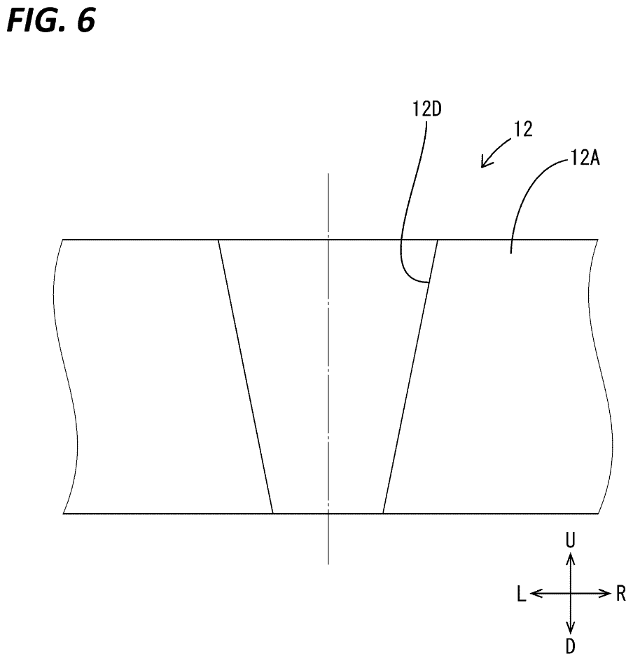

The alignment plate 12 is made of synthetic resin. As shown in FIG. 1, the alignment plate 12 includes a plate body 12A, a pair of locking pieces 12B, and a pair of guide pieces 12C. The plate body 12A has a flat plate shape with its plate thickness direction corresponding to the up-down direction (direction parallel to the axial direction Ad of the board connection portion 11B). The plate body 12A has a rectangular shape with its long sides in the left-right direction. The plate body 12A has a plurality of insertion holes 12D through which the respective plurality of board connection portions 11B are inserted. The opening shape of each insertion hole 12D is circular (see FIG. 5). Each insertion hole 12D gradually decreases in diameter from the upper end to the lower end (see FIG. 6). In FIGS. 1 and 5, only the insertion holes 12D at both ends of the plate body 12A in the left-right direction are shown and the insertion holes 12D in the center part of the plate body 12A in the left-right direction are not shown.

The pair of locking pieces 12B are provided on the respective left and right edges of the plate body 12A. The pair of locking pieces 12B rise upward from the respective left and right edges of the plate body 12A, with their upper ends protruding outward in the left-right direction.

The pair of guide pieces 12C are provided on the respective left and right edges of the plate body 12A. The pair of guide pieces 12C are located forward from the pair of locking pieces 12B. The pair of guide pieces 12C protrude outward in the left-right direction from the respective left and right edges of the plate body 12A. The guide pieces 12C can be fitted into the guide grooves 10E (not shown).

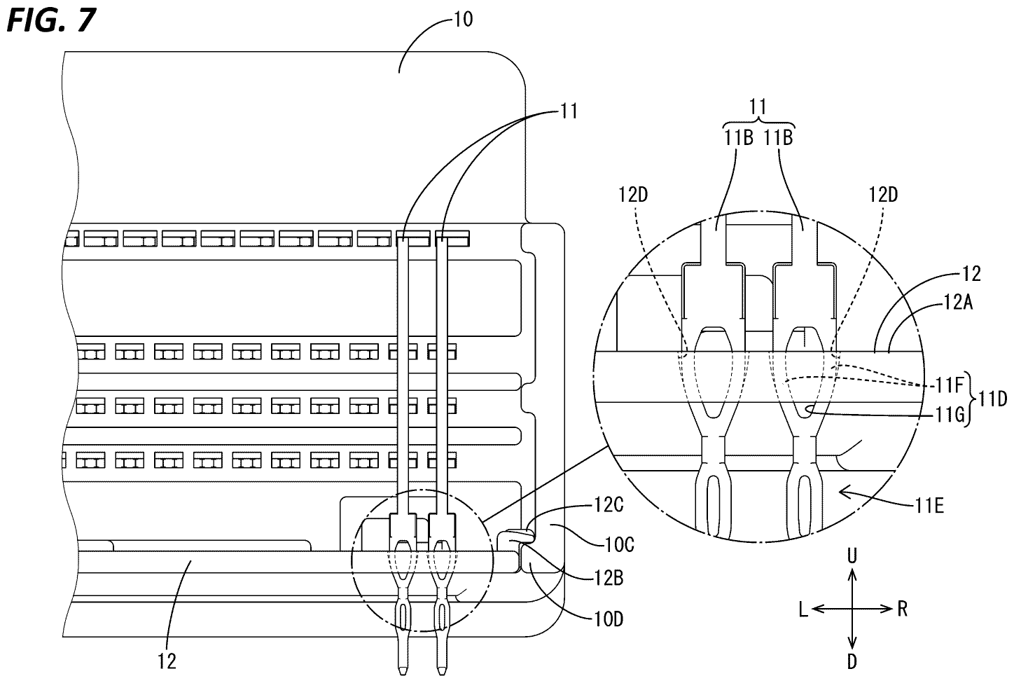

As shown in FIG. 7, the alignment plate 12 is attached between the pair of side wall portions 10C of the housing 10 with the board connection portions 11B inserted through the insertion holes 12D. Specifically, the board connection portions 11B of the terminal fittings 11 attached to the housing 10 are each inserted into the corresponding insertion hole 12D of the alignment plate 12 from above. Here, the press fit portion 11E is first inserted into the insertion hole 12D from above. The maximum width of the press fit portion 11E in the left-right direction (width direction) is smaller than the minimum dimension of the insertion hole 12D in the left-right direction (width direction) (i.e. the inner diameter of the insertion hole 12D at the lower end). Hence, the press fit portion 11E passes through the insertion hole 12D downward with little or no contact resistance between the press fit portion 11E and the insertion hole 12D.

Next, the pair of locking pieces 12B of the alignment plate 12 contact the pair of locking portions 10D of the housing 10 and elastically deform inward in the left-right direction. At the same time, the pair of guide pieces 12C are fitted into the pair of guide grooves 10E of the housing 10 (not shown).

When the upward movement of the alignment plate 12 continues, the elastic portion 11D is then inserted into the insertion hole 12D. The maximum width of the elastic portion 11D is smaller than the maximum dimension of the insertion hole 12D in the left-right direction (width direction) (i.e. the inner diameter of the insertion hole 12D at the upper end) and larger than the minimum dimension of the insertion hole 12D in the left-right direction (width direction) (i.e. the inner diameter of the insertion hole 12D at the lower end). Therefore, when the elastic portion 11D is inserted halfway through the insertion hole 12D in the up-down direction, the elastic portion 11D is stopped as a result of the outer edges of the pair of extension portions 11F contacting the inner surface of the insertion hole 12D. Here, the hole portion 11G is located so as to be out of the plate body 12A upward and downward. That is, the part of the board connection portion 11B located within the insertion hole 12D is the elastic portion 11D that is elastically deformable in the left-right direction (width direction) perpendicular to the axial direction Ad of the board connection portion 11B. Then, the upper ends of the pair of locking pieces 12B pass over the pair of locking portions 10D of the housing 10 upward, and the pair of locking pieces 12B elastically return to their original state.

Thus, the outer edges of the pair of extension portions 11F contact the inner surface of the insertion hole 12D of the alignment plate 12, as a result of which the board connection portion 11B inserted through the insertion hole 12D is relatively positioned and the alignment plate 12 is attached to the housing 10. The insertion hole 12D is capable of positioning the board connection portion 11B.

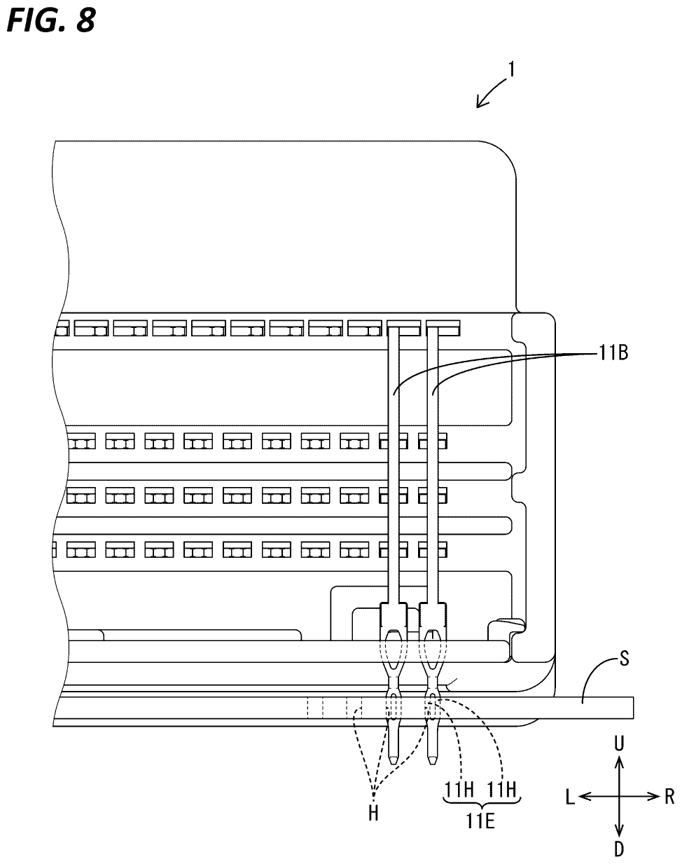

The connector 1 is attached to the circuit board S as shown in FIG. 8. Specifically, a plurality of through holes H are formed through the circuit board S in the board thickness direction. The pair of curved extension portions 11H of each press fit portion 11E are inserted through the corresponding through hole H in an elastically deformed state. For example, the press fit portion 11E is pressed into the through hole H by pressing a jig against the jig pressing surface 11K. When the press fit portion 11E is inserted through the through hole H, the pair of curved extension portions 11H elastically deform so as to approach each other. As a result, the pair of curved extension portions 11H of the press fit portion 11E elastically contact the inner surface of the through hole H. In this way, the connector 1 is attached to the circuit board S. That is, the part of the board connection portion 11B located within the through hole H of the circuit board S is the press fit portion 11E that is elastically deformable in the left-right direction (width direction).

The effects of Embodiment 1 will be described below.

A connector 1 includes: a terminal fitting 11 including a mate connection portion 11A and a board connection portion 11B; a housing 10 through which the mate connection portion 11A is inserted and held; and an alignment plate 12 attached to the housing 10 and having an insertion hole 12D capable of positioning the board connection portion 11B. A part of the board connection portion 11B of the terminal fitting 11 located within the insertion hole 12D is an elastic portion 11D that is elastically deformable in a left-right direction (width direction) perpendicular to an axial direction Ad of the board connection portion 11B.

If the alignment plate 12 is heated or cooled, its volume expands or contracts. In this case, the insertion hole 12D also expands or contracts, and becomes larger or smaller. Thus, when the alignment plate 12 expands or contracts, a pressing force is applied from the alignment plate 12 to the board connection portion 11B in a direction perpendicular to the axial direction Ad, which may cause stress on the circuit board S to which the board connection portion 11B is connected. The connector 1 according to the present disclosure can, even if the alignment plate 12 expands or contracts, absorb the pressing force from the alignment plate 12 by the elastic portion 11D and prevent stress from being applied to the circuit board S to which the board connection portion 11B is connected. Since the alignment plate 12 does not need to have an elastically deforming structure, the distance between the insertion holes 12D can be narrowed easily, which is advantageous in reducing the size of the connector 1.

A part of the board connection portion 11B to be located within a through hole H of a circuit board S is a press fit portion 11E that is elastically deformable in the width direction. This structure, as a result of having the press fit portion 11E that is elastically deformable, can further prevent stress from being applied to the circuit board S even if the board connection portion 11B is moved by the alignment plate 12.

A maximum width of the press fit portion 11E in the left-right direction (width direction) is smaller than a minimum dimension of the insertion hole 12D in the left-right direction (width direction). This structure can suppress insertion resistance that occurs when the press fit portion 11E is inserted into the insertion hole 12D.

The elastic portion 11D includes a pair of extension portions 11F extending in the axial direction Ad and connected to each other at both ends in the axial direction Ad, and a hole portion 11G formed between the pair of extension portions 11F, and a dimension of the hole portion 11G in the axial direction Ad is larger than a dimension of an eyehole 11J of the press fit portion 11E in the axial direction Ad. This structure, as a result of having the elastic portion 11D that is more flexible than the press fit portion 11E, can flexibly absorb the pressing force applied from the alignment plate 12 easily and consequently can further prevent stress from being applied to the circuit board S.

An opening shape of the insertion hole 12D is circular. This structure can easily stabilize the contact of the insertion hole 12D with the elastic portion 11D even if the elastic portion 11D tilts with respect to the axis of the board connection portion 11B.

The terminal fitting 11 includes a projection portion 11C located on an opposite side of the elastic portion 11D from the press fit portion 11E and projecting in the width direction, of both ends of the projection portion 11C in the axial direction Ad, an end located on an opposite side from the press fit portion 11E is formed as a jig pressing surface 11K in the width direction, and outer edges of the elastic portion 11D in the width direction are connected to outer edges of the projection portion 11C in the width direction without a constriction so as to be flush with each other. This structure can simplify the process of forming the terminal fitting 11 because the elastic portion 11D and the projection portion 11C can be formed integrally.

### Other Embodiments

The embodiments disclosed herein are illustrative and not restrictive in all respects. The scope of the present invention is not limited to the embodiments disclosed herein but defined by the patent claims, and is intended to include all modifications within the meaning and scope equivalent to the patent claims.

Unlike in Embodiment 1, the board connection portion may have a structure in which the extension portions of the elastic portion and the projection portions are connected with a constriction.

Unlike in Embodiment 1, the press fit portion may be omitted and the board connection portion may be inserted into the through hole and fixed to the circuit board using solder.

Unlike in Embodiment 1, the opening shape of the insertion hole may be elliptical or rectangular.

Unlike in Embodiment 1, the press fit portion may be Z-shaped, M-shaped, or the like without an eyehole.

Unlike in Embodiment 1, the elastic portion and the press fit portion may be arranged to be elastically deformable in the front-back direction.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a terminal fitting including a mate connection portion and a board connection portion;
a housing through which the mate connection portion is inserted and held; and
an alignment plate attached to the housing and having an insertion hole capable of positioning the board connection portion,
wherein a part of the board connection portion of the terminal fitting located within the insertion hole is configured as an elastic portion that is elastically deformable in a width direction perpendicular to an axial direction of the board connection portion.

2. The connector according to claim 1, wherein a part of the board connection portion to be located within a through hole of a circuit board is configured as a press fit portion that is elastically deformable in the width direction.

3. The connector according to claim 2, wherein a maximum width of the press fit portion in the width direction is smaller than a minimum dimension of the insertion hole in the width direction.

4. The connector according to claim 3, wherein the elastic portion includes a pair of extension portions extending in the axial direction and connected to each other at both ends in the axial direction, and a hole portion formed between the pair of extension portions, and
a dimension of the hole portion in the axial direction is larger than a dimension of an eyehole of the press fit portion in the axial direction.

5. The connector according to claim 1, wherein an opening shape of the insertion hole is circular.

6. The connector according to claim 4, wherein the terminal fitting includes a projection portion located on an opposite side of the elastic portion from the press fit portion and projecting in the width direction,
of both ends of the projection portion in the axial direction, an end located on an opposite side from the press fit portion is configured as a jig pressing surface in the width direction, and
outer edges of the elastic portion in the width direction are connected, without constriction, to outer edges of the projection portion in the width direction.
